(19) United States
(12) Patent Application Publication
(10) Pub. No.: US 2024/0397475 A1
(43) Pub. Date: Nov. 28, 2024

(54) SYSTEMS AND METHODS FOR CROSS-LAYER DEVICE FINGERPRINTING

(71) Applicant: The Regents of the University of California, Oakland, CA (US)

(72) Inventors: Li Xue, Oakland, CA (US); Katia Obraczka, Oakland, CA (US); Zouheir Rezki, Oakland, CA (US)

(21) Appl. No.: 18/674,658

(22) Filed: May 24, 2024

Related U.S. Application Data
(60) Provisional application No. 63/504,545, filed on May 26, 2023.

(51) Int. Cl. H04W 64/00; H04W 24/08

(52) U.S. Cl. CPC H04W 64/003; H04W 24/08

(57) ABSTRACT

The present disclosure relates to systems and methods for cross-layer device fingerprinting. A method is provided for efficiently fingerprinting networked devices, comprising, monitoring network communications of a plurality of electronic devices, extracting cross-layer features for each of the plurality of electronic devices, compiling the cross-layer features of each of the plurality of electronic devices into a device fingerprinting database, monitoring a network communication of an electronic device, extracting the cross-layer features from the network communication of the electronic device, classifying the electronic device into a device category using the cross-layer features and the device fingerprinting database, and performing a downstream network operation on the electronic device based on the device category. By extracting cross-layer features based on a downstream network operation, and pre-compiling the extracted features into a device fingerprinting database, a computational complexity of the device classification and downstream network operation may be reduced.

### CROSS-REFERENCE TO RELATED APPLICATION

The present application claims priority to U.S. Provisional Application No. 63/504,545 entitled “SYSTEMS AND METHODS FOR CROSS-LAYER DEVICE FINGERPRINTING”, and filed on May 26, 2023. The entire contents of the above-listed application are hereby incorporated by reference for all purposes.

### FIELD

The present description relates to the technical field of networked device fingerprinting.

### BACKGROUND AND SUMMARY

Device fingerprinting (FP) techniques that aim to enhance wireless network security have gained attention from the research community in recent years. FP techniques typically use device intrinsic features to uniquely identify devices. Radio Frequency fingerprinting (RF-FP) is the most common form of fingerprinting suitable for wireless networks. RF-FP is a physical layer security mechanism that extracts inherent and unique physical layer features related to hardware manufacture imperfections or imbalances in the waveform of a transmitter. Although device fingerprinting has been the focus of some research efforts, the inventors herein have identified gaps which conventional approaches have failed to address. As an example, most existing RF-FP approaches extract and analyze only physical layer characteristics, which may be difficult or computationally expensive to determine. Moreover, most conventional methodologies do not evaluate the scalability and flexibility of the selected fingerprinting features in relation to the driving application, e.g., media access control (MAC) address spoofing detection, which may benefit from an integrated approach using FP features from multiple distinct network protocol layers, rather than from the physical layer alone. There is currently no well-defined framework for selecting appropriate features from multiple network layers based on the application's requirements. And further, current techniques largely overlook the intrinsic complexity of FP and consequently, the computational resource demands of existing FP techniques may be impractical for deployment in low-end edge devices.

The above issues may be at least partially addressed by a method comprising, monitoring network communication of a plurality of electronic devices, wherein the plurality of electronic devices are communicatively coupled via a wireless network, extracting cross-layer features for each of the plurality of electronic devices using the network communication, wherein the cross-layer features are selected based on a downstream network operation, storing the cross-layer features of each of the plurality of electronic devices in a device fingerprinting database, monitoring a network communication of an electronic device communicatively coupled via the wireless network, extracting the cross-layer features from the network communication of the electronic device, classifying the electronic device into a device category using the cross-layer features of the electronic device and the device fingerprinting database, and performing the downstream network operation on the electronic device based on the device category. In this way, a computational complexity may be reduced by extracting cross-layer features based on a downstream network operation, such that only those cross-layer features used in the downstream network operation are extracted. Further, by extracting and compiling cross-layer features into a device fingerprinting database prior to executing the downstream network operation, low-grade edge devices may be enabled to perform the downstream network operation by querying the fingerprinting database, as opposed to requiring the edge devices to generate the fingerprinting database as part of the downstream network operation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a device fingerprinting system, according to an embodiment of the current disclosure;

FIG. 2 shows a flowchart of a method for compiling cross-layer device features into a device fingerprinting database, based on a downstream operation, according to an embodiment of the current disclosure;

FIG. 3 shows a flowchart of a method for classifying an electronic device based on cross-layer features extracted from communications of the electronic device, and a device fingerprinting database, according to an embodiment of the current disclosure;

FIG. 4 shows a flowchart of a method for detecting MAC address spoofing using cross-layer features and a device fingerprinting database, according to an embodiment of the current disclosure;

FIG. 5 shows a flowchart of a method for electronic device fingerprinting over a wireless network using a statistical distribution of error vector magnitudes (EVMs) as a cross-layer feature, according to an embodiment of the current disclosure; and

FIG. 6 shows a flowchart of a method for intelligently selecting cross-layer features for device fingerprinting based on requirements of a downstream network operation, according to an embodiment of the current disclosure.

### DETAILED DESCRIPTION

The following description relates to systems and methods for fingerprinting devices connected to wireless networks, using cross-layer features selected based on the driving application, also referred to herein as a downstream network operation. Downstream network operations may include, but are not limited to, MAC address spoofing detection, device localization, and quality of service (QOS) provisioning. Downstream network operations may be more efficiently executed using one or more intelligently selected cross-layer features, instead of relying solely on features from any single network layer, e.g., device intrinsic features which may be considered as arising from the physical layer, or by relying on a fixed set of features for a range of different downstream network operations, as each downstream network operation may be more efficiently executed using a distinct set of features.

As the number of end user devices connected to the Internet and their applications continue to increase, managing and administering edge and access networks has become more challenging. For instance, ensuring network security via detecting and denying or restricting access to unauthorized devices in the era of the Internet-of Things (IoT) is of increasing relevance. Flexible, efficient, and effective security mechanisms are one target in the design of today's wireless networks. Additionally, resource constraints that characterize edge devices may benefit from security solutions that have small resource footprints.

Device fingerprinting (FP) techniques that aim to enhance wireless network security have gained attention from the research community in recent years. FP techniques typically use device intrinsic features to uniquely identify devices. Radio Frequency (RF) FP is the most common form of fingerprinting used in wireless networks. RF-FP is a physical layer security mechanism that extracts inherent and unique physical layer features related to hardware manufacture imperfections or imbalances in the waveform of a transmitter. Although device fingerprinting has been the focus of some research efforts, there are still some gaps to be addressed. Most existing RF-FP approaches extract and analyze only physical layer characteristics. Moreover, most current methodologies do not evaluate the scalability and flexibility of the selected features in relation to the driving application, which may require an integrated approach using FP features from different network protocol layers rather than from the physical layer only. There is not yet a well-defined framework for selecting appropriate features from various network layers based on the application's requirements. In addition, most existing techniques rely solely on experimental findings to select and extract FP features. Empirical approaches make it difficult to select appropriate features for specific applications without a thorough theoretical understanding. Lastly, current techniques largely overlook the intrinsic complexity of FP and instead rely entirely on the correctness of the proposed FP analysis algorithms. Consequently, the complexity and computational resource needs of existing FP techniques may be too high and thus impractical for deployment in low-end edge devices.

The inventors herein disclose systems and methods of cross-layer device fingerprinting (CL-FP), with the goal of closing the gaps discussed above, opening the way for the deployment of an end-to-end, scalable, lightweight, and reliable FP system. The disclosed systems and methods aim at identifying and extracting inherent cross-layer device features based on the requirements of the downstream network operations. The current disclosure discusses embodiments relating to MAC spoofing attack detection, but it will be appreciated that the disclosed approaches may be extended to additional downstream network operations, including device localization, QoS provisioning, and other downstream network operations known in the art of wireless networking.

In particular, the inventors herein have experimentally confirmed that easier to-extract FP features, such as the error vector magnitude (EVM), may reliably represent harder-to-extract intrinsic physical characteristics of devices, and incorporate these FP features into a lightweight, scalable, and reliable end-to-end cross-layer device fingerprinting framework, which may enable low end edge devices to conduct downstream network operations using the FP features. The EVM provides a measure of the difference between the ideal constellation point and the actual received constellation point for a given modulation scheme. This difference arises due to, and is therefore correlated with, various hardware imperfections in the transmitter and receiver components, such as phase noise, I/Q imbalance, nonlinearities in the power amplifier, and quantization noise in the analog-to-digital converters. These imperfections are unique to each individual device and stem from slight variations in the manufacturing process of the analog components. As a result, the EVM encapsulates a “fingerprint” of the hardware imperfections specific to a given wireless device. By extracting and analyzing the EVM from wireless transmissions, the current disclosure exploits these hardware fingerprints to uniquely identify individual devices on the network.

One advantage of using the EVM as a fingerprinting feature is that it captures the cumulative effects of all hardware imperfections in a single metric that is readily available from the physical layer of modern wireless systems. Alternative approaches that attempt to estimate each hardware impairment separately would require more complex modeling and parameter estimation, increasing the computational overhead. The EVM, in contrast, can be computed efficiently from the error vector between the received signal and an idealized reference signal, making it suitable for lightweight implementations. Furthermore, the EVM is inherently robust to changing network conditions since it is normalized by the root mean square amplitude of the ideal signal constellation, providing resilience against fluctuations in the received signal strength.

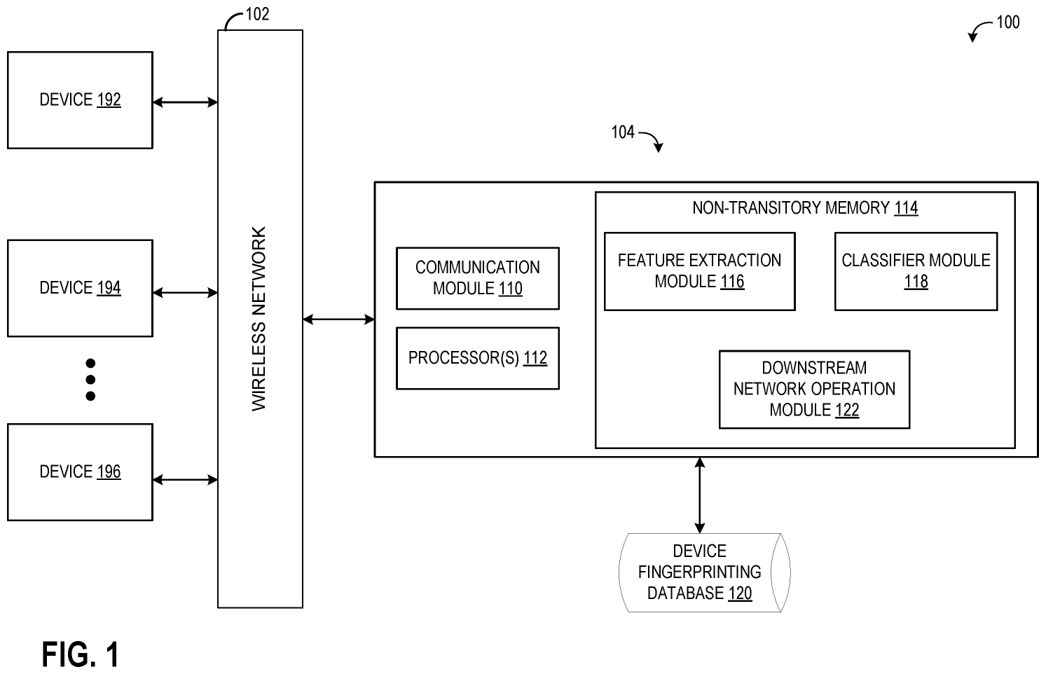

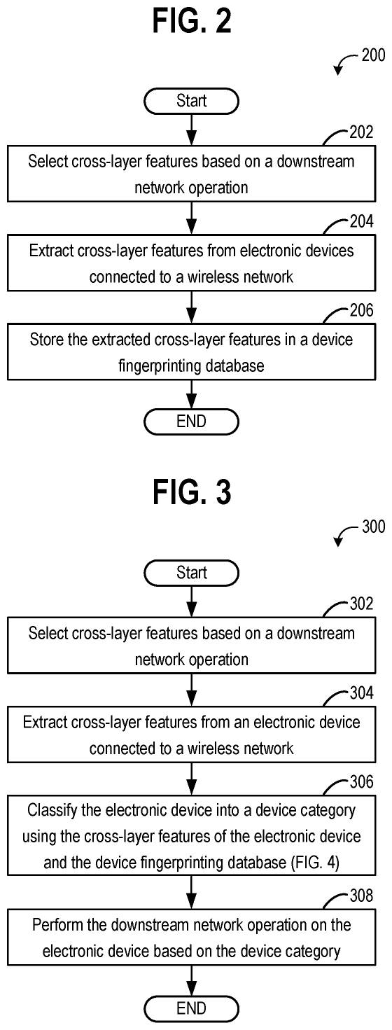

In one example, a device fingerprinting system, such as device fingerprinting system 100, shown in FIG. 1, may compile a device fingerprinting database by monitoring communications from a plurality of electronic devices transmitted over a wireless network, extracting cross-layer features from the communications based on one or more downstream network operations to be performed, and storing the extracted cross-layer features in a device fingerprinting database, according to one or more operations described in method 200, shown in FIG. 2. The device fingerprinting database may later be utilized according to one or more operations of method 300, shown in FIG. 3, to classify electronic devices into pre-determined device categories.

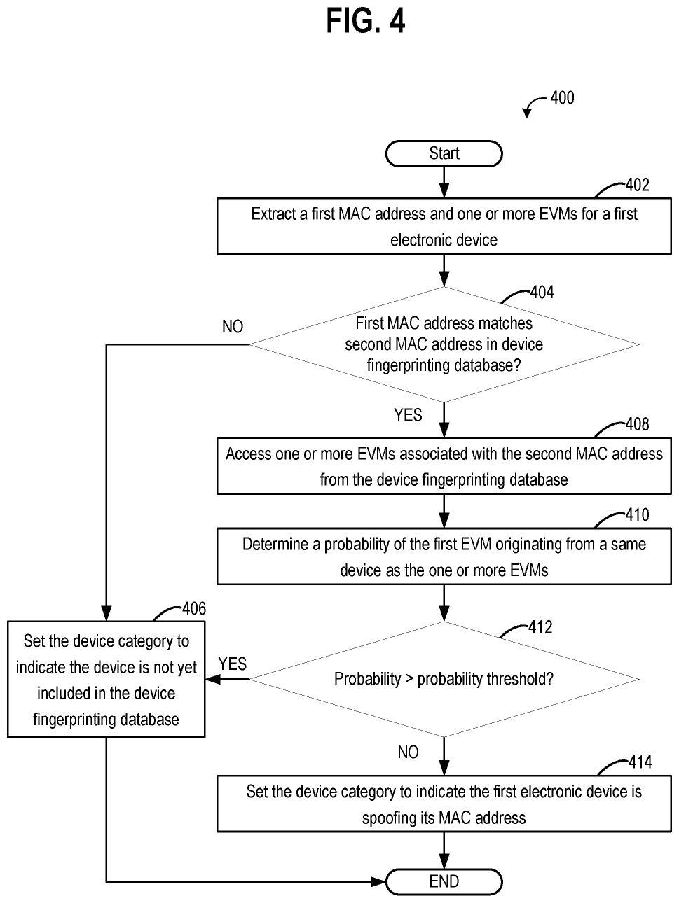

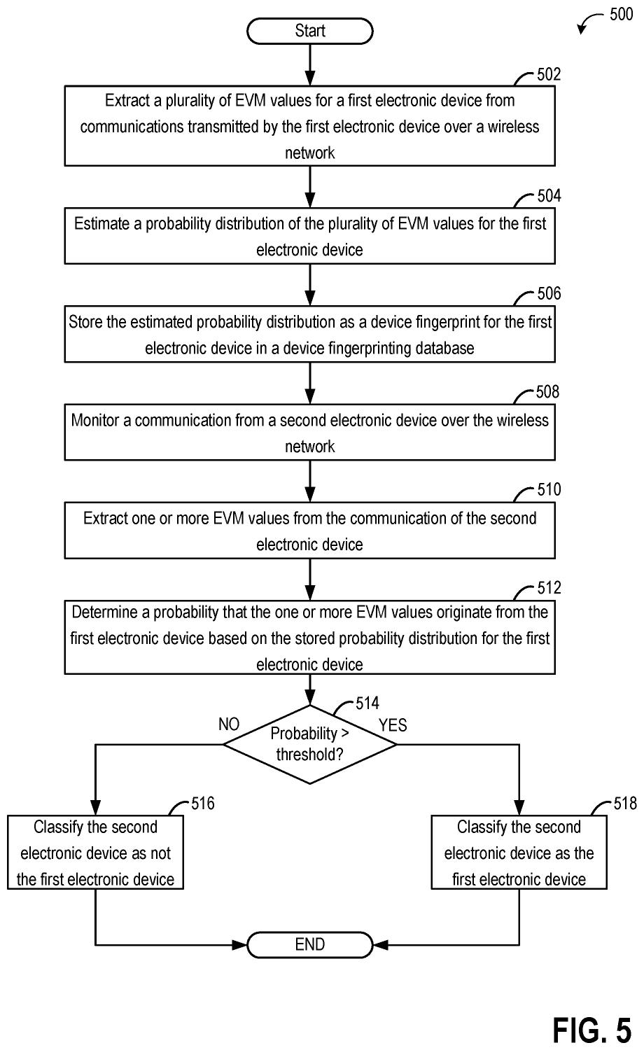

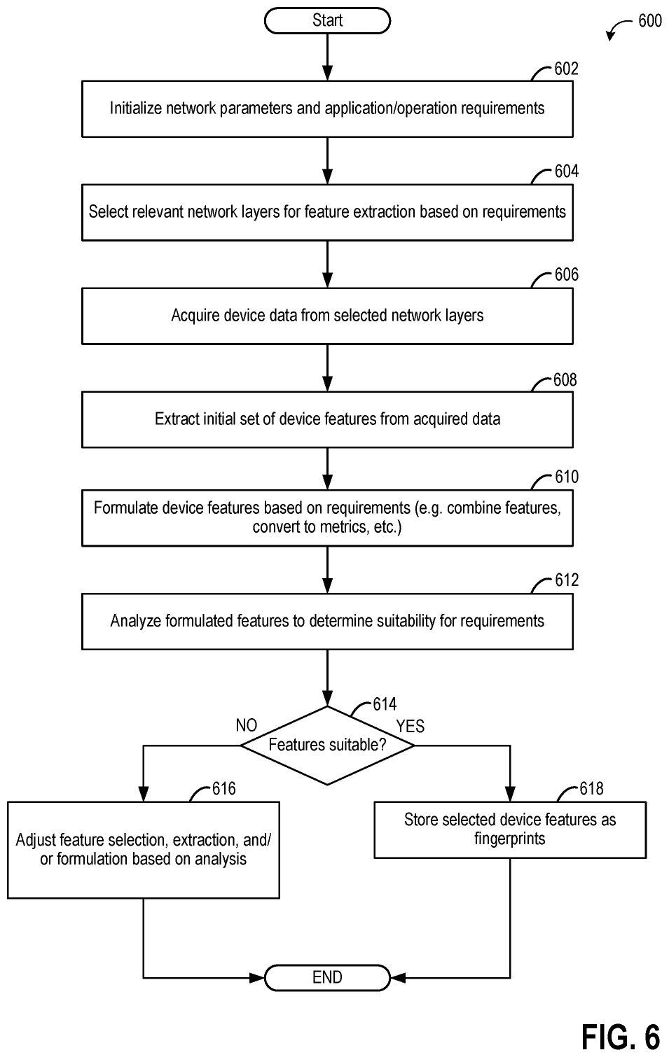

In a particular example, shown by method 400 in FIG. 4, cross-layer features comprising a MAC address and an EVM may be used to classify a first electronic device as “spoofing” or “not spoofing” its MAC address, by determining the probability that the EVM produced by the first electronic device, and one or more EVMs accessed from a device fingerprinting database, indexed by the MAC address of the first electronic device, originate from a same device. The one or more EVMs stored in the device fingerprinting database may have been previously extracted from a second device with a same MAC address as the first device. A low probability of the EVMs originating from a same device may indicate that the first electronic device is spoofing its MAC address, and therefore may be classified by method 400 into a device category indicating the first device is spoofing its MAC address. Alternatively, the classification could determine the first device is an authorized or unauthorized device, identify the specific device model, or categorize the device into a broader device type. FIG. 5 outlines method 500 for electronic device fingerprinting over a wireless network, wherein an EVM distribution is utilized as a cross-layer feature for fingerprinting devices. FIG. 6 describes method 600 for intelligently selecting cross-layer features for device fingerprinting, tailored to the requirements of a particular downstream network operation.

As used herein, the term cross-layer feature or cross-layer features, refers to device features from multiple, distinct network layers (e.g., physical layer, MAC layer, etc.). cross-layer features may include MAC-layer clock skew, MAC-layer frame inter arrival times, RF features, network-layer packet inter-arrival times, and application-layer traffic patterns, and more. In one example, the inventors herein have experimentally determined that the EVM can be expressed as a unique function of a device's I/Q gain imbalance, which is independent of the modulation scheme. In other words, the EVM may be used as a proxy to represent a transmitter's I/Q gain imbalance, assuming constant signal-to-noise ratio and perfect transmitter phase imbalance, and thus can be used to fingerprint devices. When used along with a device's MAC address, the EVM may be used to detect spoofed MAC addresses, with a substantial reduction in computational expense, compared to approaches which fingerprint devices using direct calculation of physical layer features.

A network operation, as used herein, refers to a task or function performed within a network environment, typically involving the management, control, or monitoring of network devices and their communications. Network operations may include, but are not limited to, security operations such as detecting and mitigating network attacks or unauthorized access attempts, QoS operations for managing network resources and prioritizing traffic, localization operations for determining the physical location of network devices, and device identification or authentication operations for verifying the identity and legitimacy of devices connected to the network. Network operations may be performed by network infrastructure components, such as routers, switches, access points, or dedicated network management systems, and may involve the analysis and processing of various network data, including device characteristics, traffic patterns, and communication parameters.

Referring to FIG. 1, a device fingerprinting system 100 is shown. Device fingerprinting system 100 includes a plurality of electronic devices (device 192, device 194, and device 196), communicatively coupled with an edge device 104, via a wireless network 102. Although three devices are shown communicatively coupled with edge device 104, it will be appreciated that substantially any number of electronic devices may be communicatively coupled with edge device 104. Devices 192, 194, and 196, may also be referred to as end devices, end user devices, or other similar terms. In some embodiments, devices 192, 194, and 196 may comprise user devices such as cellphones, laptops, tablets, and/or network enabled devices, including smart appliances, smart wearables (e.g., smart watches, glucose monitors, etc.), access points (APs), and network enabled sensors. Edge device 104 may be hardware constrained, e.g., edge device 104 may comprise less RAM, memory, or include a processor with lower capacity (e.g., lower instructions per second) than larger centralized servers. Edge device 104 may be configured to fingerprint end devices, such as devices 192, 194, and 196, by executing one or more operations of methods 200, 300, and 400, described below.

Edge device 104 includes a processor 112 configured to execute machine readable instructions stored in non-transitory memory 114, or received by communication module 110. Processor 112 may be single core or multi-core, and the programs executed thereon may be configured for parallel or distributed processing. In some embodiments, processor 112 may optionally include individual components that are distributed throughout two or more devices, which may be remotely located and/or configured for coordinated processing. In some embodiments, one or more aspects of processor 112 may be virtualized and executed by remotely-accessible networked computing devices configured in a cloud computing configuration.

Edge device 104 includes communication module 110. Communication module 110 may be configured to provide access to at least one of wireless network 102, other access networks, and/or at least one communication transport protocol, for example, Ethernet, Mobile IP, Frame Relay, Bluetooth, and/or Wi-Fi protocols (including 5G, 5G+, and Lora), along with any related software, for the purpose of monitoring communications transmitted by devices 192, 194 and 196, such as, for example, traffic information, device type, application type, and/or mode of usage. Communication module 110 may be configured to act as node in a communication network, by forwarding data items received from a first network device to a second network device. In some embodiments, edge device 104 may be configured to bridge end devices and more centralized devices, such as servers. Communication module 110 may also authenticate communications from end devices, such as devices 192, 194, and 196, and verify the authenticity of an incoming data item.

Edge device 104 includes non-transitory memory 114, which may include instructions executable by processor 112. In some embodiments, non-transitory memory 114 may include components disposed at two or more devices, which may be remotely located and/or configured for coordinated processing. In some embodiments, one or more aspects of non-transitory memory 114 may include remotely-accessible networked storage devices configured in a cloud computing configuration.

Non-transitory memory 114 includes a feature extraction module 116 comprising instructions for extracting cross-layer features from communications received by communication module 110. In some embodiments feature extraction module 116 may include instructions for determining a MAC address and EVM for one or more of devices 192, 194, and 196, based on communications received by communication module 110.

Non-transitory memory 114 further includes classifier module 118, which comprises instructions for classifying a device (such as devices 192, 194, and 196) into one or more pre-determined device categories based on a comparison between cross-layer features extracted from communications received from the device, and cross-layer features stored in device fingerprinting database 120.

Edge device 104 is communicatively coupled to a device fingerprinting database 120, which is configured to store cross-layer features extracted by feature extraction module 116. The remote device fingerprinting database 120 may include instructions for performing operations associated with manipulating the cross-layer features stored therein, such as sorting, searching, querying, or analyzing the cross-layer features. Furthermore, the remote device fingerprinting database 120 may also include metadata associated with the stored cross-layer features. By locating the device fingerprinting database 120 remotely from edge device 104, some of the computational and memory demands are offloaded from the edge device 104. Edge device 104 is enabled to access and communicate with the cross-layer feature data stored in the remote device fingerprinting database 120 via network communication, e.g., via API calls or other remote data access protocols.

In some embodiments, classifier module 118 may include instructions for performing one or more supervised or unsupervised machine learning algorithms, such as clustering, k-nearest neighbors, approximate k-nearest neighbors. The k-nearest neighbors algorithm may compute distance metrics between the cross-layer features extracted for an electronic device, and cross-layer features stored in the device fingerprinting database, in order to classify the electronic device into a device category associated with the devices from the database having the smallest distance between cross-layer features. In some embodiments, classifier module 118 may include one or more neural networks, such as a Siamese neural network, a multi-layer perceptron, or other neural networks known in the art of machine learning.

Non-transitory memory further includes downstream network operation module 122, which may store instructions for performing one or more downstream network operations, based on device categories determined for one or more end devices by classifier module 118. In some embodiments, downstream network operation module may store cross-layer features to be used in device classifications used in particular downstream network operations. As an example, for the downstream network operation of MAC address spoofing detection, the downstream network operation module 122 may include identifiers for cross-layer features to be used to detect if a device's MAC address is being spoofed.

Referring to FIG. 2, a flowchart of a method 200 for compiling a device fingerprinting database, is shown. The device fingerprinting database generated by method 200 may be used to classify a device, by comparing cross-layer features extracted from communications transmitted by the device, with previously extracted cross-layer features stored in the device fingerprinting database, such as at operation 306 of method 300. Method 200 may be executed by a device fingerprinting system, such as device fingerprinting system 100, shown in FIG. 1.

Method 200 begins at operation 202, wherein the device fingerprinting system selects cross-layer features based on a downstream network operation. In some embodiments, cross-layer features to be extracted may be associated with corresponding downstream network operations, and stored in non-transitory memory of the device fingerprinting system, such as in downstream network operation module 122. As an example, in embodiments where the downstream network operation to be performed by the device fingerprinting system is MAC spoofing detection, the cross-layer features of MAC address and EVM may be determined by accessing an entry stored in non-transitory memory of the device fingerprinting system, wherein the entry comprises a name or ID number of the downstream network operation to be performed, and a list of the one or more types of cross-layer features to be extracted.

At operation 204, the device fingerprinting system extracts the selected cross-layer features from electronic devices connected to a wireless network. In some embodiments, the selected cross-layer features determined at operation 202 may be communicated to a feature extraction module of the device fingerprinting system, and utilized to extract features from communications received from end devices by a communication module of the device fingerprinting system. In some embodiments, the device fingerprinting system may extract the selected cross-layer features from multiple, distinct communications of a same end device, thereby producing a plurality of measurements of the selected cross-layer features, enabling statistics of the cross-layer features, such as standard deviation, mean, etc. to be ascertained, and to better estimate intrinsic device level characteristics of the device. The device fingerprinting system may extract the selected cross-layer features for each of a plurality of end devices communicatively coupled with a particular network. In one example, the device fingerprinting system may extract N EVM values from N distinct communications of each of a plurality of end devices, wherein N is positive integer greater than one, and wherein each of the N EVM values is associated with a unique MAC address, derived from the N distinct communications from each of the plurality of devices.

At operation 206, the device fingerprinting system stores the extracted cross-layer features in a device fingerprinting database. In some embodiments, each of a plurality of duplicate cross-layer features for each of a plurality of devices communicatively coupled to the device fingerprinting system may be stored in the device fingerprinting database. In some embodiments, statistics computed based on the duplicate cross-layer feature values may also be stored in the device fingerprinting database. As an example, in instances where the downstream network operation is MAC address spoofing detection, operation 206 may include storing each of a plurality of EVMs determined for a particular end device, along with the MAC address determined for the particular end device, as an entry in the device fingerprinting database. Further, in some embodiments, statistics computed for the plurality of EVMs, such as the standard deviation and mean of the plurality of EVMs, may also be stored in the entry for the particular end device, within the device fingerprinting database. Following operation 206, method 200 may end. In this way, a device fingerprinting database may be pre-compiled, enabling edge devices with potentially limited hardware capacity, such as edge device 104, to execute downstream network operations with a reduced computational demand.

Referring to FIG. 3, a flowchart of a method 300 for classifying a device into one or more pre-determined device categories, using cross-layer features extracted from communications received from the device, and a device fingerprinting database, is shown. Method 300 may be executed by a device fingerprinting system, such as device fingerprinting system 100, shown in FIG. 1. In some embodiments, method 300 may be executed as part of a downstream network operation, such as MAC spoofing detection, device localization, or QoS provisioning.

Method 300 begins at operation 302, wherein the device fingerprinting system selects cross-layer features based on a downstream network operation. In some embodiments, cross-layer features to be extracted may be stored in a location of non-transitory memory associated with a corresponding downstream network operation. As an example, in embodiments where the downstream network operation to be performed by the device fingerprinting system is MAC address spoofing detection, the cross-layer features of MAC address and EVM may be determined by accessing an entry stored in non-transitory memory of the device fingerprinting system, wherein the entry comprises a name or ID number of the downstream network operation to be performed, and a list of the one or more types of cross-layer features to be extracted.

At operation 304, the device fingerprinting system extracts cross-layer features from an electronic device connected to a wireless network. In some embodiments, the device fingerprinting system processes or decodes end device information, and extracts the selected cross-layer features specific to the downstream network operation. The cross-layer features may be extracted from various network layers, including the physical layer, the MAC layer, and the application layer.

At operation 306, the device fingerprinting system classifies the electronic device into a device category using the cross-layer features of the electronic device and the device fingerprinting database. In some embodiments, a machine learning approach, including one or more of a nearest neighbors algorithm, a clustering algorithm, and a trained neural network, may be used to classify, identify, cluster, authenticate, and/or authorize the device, based on features previously extracted from one or more network layers for devices previously or currently connected to the wireless network. The device category may include categories for device identification (determining the specific device model or type), device classification (grouping the device into a broader category like smartphone, laptop, IoT device, etc.), and device authorization (determining if the device is authorized to access the network based on its fingerprint matching an approved device). For example, the device fingerprinting system may determine a similarity score between the cross-layer features of the electronic device and the cross-layer features of each of the plurality of electronic devices stored in the device fingerprinting database. The similarity score may be computed as a distance metric between the cross-layer features of the electronic device and the cross-layer features of each device in the database. The electronic device may then be assigned to the device category associated with the electronic device from the database having the highest similarity score, i.e., the smallest distance between cross-layer features.

At operation 308, the device fingerprinting system performs the downstream network operation on the electronic device based on the device category. In one embodiment, at operation 308, if the device category determined at operation 306 indicates the electronic device is spoofing its MAC address, an unauthorized device, or matches a device that is denied network access, the device fingerprinting system may prevent the electronic device from continuing to communicate over the wireless network. In another embodiment, if the device category indicates the device is an approved device authorized for network access, the device fingerprinting system may allow the device's communications over the wireless network.

Referring now to FIG. 4, an embodiment of a method 400 for classifying a first electronic device into one of a pre-determined number of device categories, is shown. In some embodiments, method 400 may be employed to secure a wireless network by detecting MAC address spoofing, utilizing a pre-compiled device fingerprinting database storing cross-layer features for a plurality of electronic devices.

Method 400 begins at operation 402, wherein the device fingerprinting system extracts a first MAC address and one or more EVMs from communications transmitted by a first electronic device, over a wireless network. In some embodiments, the one or more EVMs of the first electronic device may be related to the I/Q gain imbalance of the transmitter of the first electronic device, by the following equation:

$${EVM}_{rms , avg} = \sqrt{\frac{1}{SNR} + 2 - \sqrt{2 + \frac{4 {g}_{t}}{1 + {g}_{t}^{2}}}}$$

Where EV M_{rms,avg} is the root mean square (RMS) of the error vectors computed and normalized to the average symbol power of the EVM reference,

$$SNR = \frac{{E}_{s}}{{N}_{0}} ,$$

where Eₛ is the average signal symbol energy, and N₀ is the power spectral density (PSD) of white Gaussian noise, and gₜ is the I/Q gain imbalance of the transmitter.

The device fingerprinting system may determine EV M_{rms,avg} for the communications transmitted by the first electronic device using the standards defined by the IEEE. In one example, the EVMs may be calculated by finding the ideal constellation location for each received symbol, and taking the root mean square error of all error vector magnitudes between the received symbol locations and their closest ideal constellation locations.

At operation 404, the device fingerprinting system determines if the first MAC address matches a second MAC address in the device fingerprinting database. If at operation 404 the device fingerprinting system determines that no MAC address stored in the device fingerprinting database matches the first MAC address, method 400 may proceed to operation 406. At operation 406, the device fingerprinting system sets the device category of the first electronic device to indicate the device is not yet included in the device fingerprinting database. By setting the device category to indicate the device is not yet included, the system is flagging the electronic device for cross-layer feature extraction and subsequent addition of these extracted cross-layer features to the fingerprinting database. In some embodiments, statistics like means and standard deviations of the extracted features may be calculated to build a fingerprint model for the new device. Once the fingerprinting process is complete, an entry can be added to the database containing the extracted cross-layer features and associated fingerprint model, indexed by the device's MAC address. This allows the fingerprinting database to be continuously updated with emerging devices, while preventing new devices from being incorrectly flagged as potential MAC address spoofers before they are fingerprinted.

However, if at operation 404, the device fingerprinting system determines that a second MAC address stored within the device fingerprinting database matches the first MAC address, method 400 may proceed to operation 408. At operation 408, the device fingerprinting system accesses one or more EVMs associated with the second MAC address from the device fingerprinting database. In some embodiments, the fingerprinting system may access an entry of the device fingerprinting database indexed by the second MAC address, wherein the entry includes the one or more EVMs previously extracted from a second device using the second MAC address.

At operation 410, the device fingerprinting system determines a probability of the one or more EVMs acquired at operation 402 originating from a same device as the one or more EVMs accessed at operation 408 from the device fingerprinting database. In some embodiments, a machine learning technique, such as nearest neighbors may be used to determine the probability of the EVMs extracted from the communication of the first device, and the one or more EVMs stored in the device fingerprinting database, and associated with the second MAC address, originating from a same device. In one embodiment, the nearest neighbors algorithm may compute a distance metric, such as Euclidean distance, between the first EVM and each of the one or more EVMs from the database, in order to determine the probability that the EVMs originated from the same device as the EVMs in the database. In one embodiment, the following algorithm may be used to determine the probability, p, of the first EVM and the one or more EVMs originating from a same device:

```
psum = 0
for EVM_ref in DB[i]:
  d = abs(EVM_test − EVM_ref)
  if d < epsilon:
    psum += 1
p = psum/len(DB[i])
if p > eta:
  MAC_spoofing = False
else:
  MAC_spoofing = True
```

Where DB[i] is the list of the one or more EVMs stored in the device fingerprinting database associated with the second MAC address, EVM_test is the set of EVMs determined at operation 402, EVM_ref iterates over the one or more EVMs stored in DB[i], d is the absolute value of the difference between the current reference EVM and set of EVMs determined at operation 402, epsilon is an EVM difference threshold, wherein EVMs with an absolute value difference less than epsilon are considered to have originated from a same device, psum counts the number of the one or more EVMs associated with the second MAC address which are within epsilon of the set of EVMs determined at operation 402, eta is a probability threshold, wherein probabilities greater than eta indicate the EVMs determined for the first device are not statistically distinct from the one or more EVMs (and thus are likely to have originated from a same device, as the EVM correlates with the I/Q gain imbalance of the transmitter of the device), and MAC_spoofing is a boolean variable to hold the device category of the first device (in the above example, a value of False indicates no MAC addressing spoofing, while a value of True indicates MAC address spoofing). In some embodiments, the EVM difference threshold, epsilon, is set to the standard deviation of the one or more EVM values stored in the device fingerprinting database, and associated with the second MAC address.

At operation 412, the device fingerprinting system determines if the probability of the first EVM and the one or more EVMs originating from a same device is greater than a probability threshold. If at operation 412 the device fingerprinting system determines that the probability of the first EVM originating from a same device as the one or more EVMs is above a threshold probability, method 400 may proceed to operation 406, wherein the device fingerprinting system sets the device category of the first electronic device to indicate the device is not spoofing its MAC address.

At operation 414, the device fingerprinting system sets the device category to indicate the first electronic device is spoofing its MAC address. Following operation 414, method 400 may end. The device category determined by method 400 may be used as part of a larger method, e.g., to execute a downstream network operation, such as preventing communications with spoofed MAC address from being transmitted through a wireless network monitored by the device fingerprinting system. In this way, a device fingerprinting system with potentially limited hardware capacity may efficiently classify an end device into a device category, and execute downstream network operations on the device based on the device category, using a pre-compiled device fingerprinting database.

Referring to FIG. 5, a flowchart of a method 500 for electronic device fingerprinting over a wireless network is shown. Method 500 may be executed by a device fingerprinting system, such as device fingerprinting system 100, shown in FIG. 1. Method 500 utilizes the Error Vector Magnitude (EVM) as a cross-layer feature for fingerprinting electronic devices communicatively coupled to a wireless network.

Method 500 begins at operation 502, wherein the device fingerprinting system extracts a plurality of EVM values for a first electronic device from communications transmitted by the first electronic device over a wireless network. In some embodiments, the device fingerprinting system may monitor communications transmitted by the first electronic device over an extended period of time, extracting multiple EVM values from distinct communications of the first electronic device at multiple time instances during the period of time. The plurality of EVM values extracted from the communications of the first electronic device may provide a statistical representation of the intrinsic hardware characteristics of the first electronic device, such as the I/Q gain imbalance of the transmitter of the first electronic device. The device fingerprinting system may update the device fingerprinting database with the extracted EVM values at the multiple time instances during the period of time, enabling the device fingerprint for the first electronic device to be updated over time as the hardware characteristics potentially change.

At operation 504, the device fingerprinting system estimates a probability distribution of the plurality of EVM values for the first electronic device. In one embodiment, the device fingerprinting system may fit a Gaussian distribution to the plurality of EVM values extracted for the first electronic device at operation 502. The device fingerprinting system may determine the mean and standard deviation of the plurality of EVM values to parameterize the Gaussian distribution. In another embodiment, the device fingerprinting system may employ a non-parametric approach to estimate the probability distribution of the plurality of EVM values, such as by constructing a histogram of the EVM values.

At operation 506, the device fingerprinting system stores the estimated probability distribution as a device fingerprint for the first electronic device in a device fingerprinting database. The device fingerprinting database may be stored in non-transitory memory of the device fingerprinting system, such as device fingerprinting database 120 stored in non-transitory memory 114 of device fingerprinting system 100. In some embodiments, the device fingerprinting database may store the parameters of the estimated probability distribution, such as the mean and standard deviation of a Gaussian distribution fit to the plurality of EVM values extracted for the first electronic device. In other embodiments, the device fingerprinting database may store a histogram or other non-parametric representation of the estimated probability distribution of the plurality of EVM values for the first electronic device. The device fingerprinting database may be updated with the EVM values extracted at multiple time instances during the period of time that the first electronic device is monitored, enabling the device fingerprint to evolve over time.

At operation 508, the device fingerprinting system monitors a communication from a second electronic device over the wireless network. The second electronic device may be distinct from the first electronic device fingerprinted at operations 502-506. In some embodiments, the device fingerprinting system may monitor communications from a plurality of electronic devices communicatively coupled to the wireless network.

At operation 510, the device fingerprinting system extracts one or more EVM values from the communication of the second electronic device. In one embodiment, the device fingerprinting system may extract a single EVM value from the communication of the second electronic device. In another embodiment, the device fingerprinting system may extract multiple EVM values from distinct portions of the communication from the second electronic device, or from multiple communications transmitted by the second electronic device.

At operation 512, the device fingerprinting system determines a probability that the one or more EVM values extracted from the communication of the second electronic device originate from the first electronic device, based on the stored probability distribution for the first electronic device. In one embodiment where the device fingerprinting database stores a Gaussian distribution parameterized by a mean and standard deviation fit to the plurality of EVM values extracted for the first electronic device, the device fingerprinting system may determine the probability that the one or more EVM values extracted from the second electronic device belong to the Gaussian distribution associated with the first electronic device. In another embodiment where the device fingerprinting database stores a histogram representation of the probability distribution of the plurality of EVM values for the first electronic device, the device fingerprinting system may determine the probability that the one or more EVM values extracted from the second electronic device fall within one or more bins of the histogram.

At operation 514, the device fingerprinting system determines if the probability determined at operation 512 is greater than a predetermined threshold. If the probability is greater than the predetermined threshold, method 500 proceeds to operation 518. However, if the probability is less than or equal to the predetermined threshold, method 500 proceeds to operation 516.

At operation 516, the device fingerprinting system classifies the second electronic device as not being the first electronic device. In some embodiments, the device fingerprinting system may store an indication that the second electronic device is distinct from the first electronic device in the device fingerprinting database. Following operation 516, method 500 may end.

At operation 518, the device fingerprinting system classifies the second electronic device as the first electronic device. In some embodiments, the device fingerprinting system may store an indication that the second electronic device is the same device as the first electronic device in the device fingerprinting database. Following operation 518, method 500 may end.

In this way, method 500 enables a device fingerprinting system to fingerprint electronic devices communicatively coupled to a wireless network using the EVM as a cross-layer feature. By extracting a plurality of EVM values from communications of a first electronic device, estimating a probability distribution of the plurality of EVM values, and storing the estimated probability distribution in a device fingerprinting database, the device fingerprinting system may later classify additional electronic devices communicating over the wireless network as either being or not being the first electronic device. The classification is performed by extracting one or more EVM values from communications of the additional electronic devices, and determining the probability that the one or more extracted EVM values originate from the same device as the first electronic device, based on the stored probability distribution associated with the first electronic device. This approach reduces computational complexity compared to techniques which extract intrinsic physical layer features directly, while still enabling device fingerprinting based on hardware imperfections which manifest in the EVM.

Referring to FIG. 6, a flowchart of a method 600 for intelligently selecting cross-layer features for device fingerprinting is shown. Method 600 may be executed by a device fingerprinting system, such as device fingerprinting system 100 shown in FIG. 1.

Method 600 begins at operation 602, wherein the device fingerprinting system initializes network parameters and application/operation requirements. In some embodiments, operation 602 may include determining one or more downstream network operations to be performed by the device fingerprinting system, such as media access control (MAC) address spoofing detection, device localization, or quality of service (QOS) provisioning. The device fingerprinting system may access a database or other data structure stored in non-transitory memory, such as downstream network operation module 122 shown in FIG. 1, to determine the downstream network operation(s) to be performed, and retrieve any associated requirements or parameters. For example, in instances where the downstream network operation is MAC address spoofing detection, the device fingerprinting system may retrieve an indication that the cross-layer features of MAC address and error vector magnitude (EVM) are to be extracted and utilized.

At operation 604, the device fingerprinting system selects relevant network layers for feature extraction based on the requirements determined at operation 602. In some embodiments, operation 604 may include accessing a mapping or lookup table stored in non-transitory memory, wherein the mapping associates particular downstream network operations with one or more network layers from which features are to be extracted. For the MAC address spoofing detection use case, the device fingerprinting system may determine that the MAC layer and the physical layer are the relevant network layers from which to extract features. In another example, for a downstream network operation of device localization, the device fingerprinting system may determine that features are to be extracted from the application layer, the network layer, and the physical layer.

At operation 606, the device fingerprinting system acquires device data from the selected network layers determined at operation 604. In some embodiments, operation 606 may include monitoring communications transmitted by one or more electronic devices over a wireless network, and capturing data transmitted over the selected network layers. For example, in instances where the MAC layer and physical layer were selected at operation 604, the device fingerprinting system may capture MAC layer data such as frame inter-arrival times and MAC addresses, as well as physical layer data such as in-phase and quadrature (I/Q) samples of transmitted waveforms.

At operation 608, the device fingerprinting system extracts an initial set of device features from the acquired data. In some embodiments, operation 608 may include decoding or demodulating the acquired data to extract device features in accordance with known protocols and standards associated with the selected network layers. For the MAC layer, operation 608 may include extracting a MAC address by decoding a frame header. For the physical layer, operation 608 may include calculating an error vector magnitude (EVM) from the I/Q samples by comparing the received signal to an ideal constellation point. In some embodiments, operation 608 may produce a plurality of measurements for a particular device feature, enabling statistics such as mean and standard deviation to be computed.

At operation 610, the device fingerprinting system formulates the device features extracted at operation 608 based on the requirements determined at operation 602. In some embodiments, operation 610 may include combining two or more extracted device features into a single feature, converting extracted device features into alternative metrics, or otherwise processing the extracted device features to produce a formulated set of device features tailored to the downstream network operation. As an example, for the MAC address spoofing detection use case, operation 610 may include pairing each extracted MAC address with a corresponding EVM to produce a set of (MAC address, EVM) pairs, wherein each pair comprises a distinct device feature. In another example, for a downstream network operation of device localization, operation 610 may include converting extracted physical layer features into a received signal strength indicator (RSSI), which may be combined with extracted application layer features to formulate a device location fingerprint.

At operation 612, the device fingerprinting system analyzes the formulated features produced at operation 610 to determine their suitability for the requirements of the downstream network operation determined at operation 602. In some embodiments, operation 612 may include evaluating the formulated features against one or more pre-determined criteria, such as computational complexity, robustness to noise or interference, and ability to uniquely identify devices. The device fingerprinting system may employ one or more machine learning techniques, such as clustering or classification algorithms, to assess the suitability of the formulated features. In some embodiments, operation 612 may produce a suitability score or other metric indicating the degree to which the formulated features satisfy the requirements of the downstream network operation.

At operation 614, the device fingerprinting system determines if the formulated features are suitable for the requirements of the downstream network operation, based on the analysis performed at operation 612. If the device fingerprinting system determines that the formulated features are suitable, method 600 may proceed to operation 618. However, if the device fingerprinting system determines that the formulated features are not suitable, method 600 may proceed to operation 616.

At operation 616, the device fingerprinting system adjusts the feature selection, extraction, and/or formulation based on the analysis performed at operation 612. In some embodiments, operation 616 may include selecting additional network layers from which to extract device features, modifying the feature extraction process at operation 608, or altering the feature formulation process at operation 610. The device fingerprinting system may iteratively execute operations 608, 610, 612, and 616 until a suitable set of formulated features is produced, or until a pre-determined number of iterations has been reached.

At operation 618, the device fingerprinting system stores the selected device features as fingerprints. In some embodiments, operation 618 may include storing the formulated device features in a device fingerprinting database, such as device fingerprinting database 120 shown in FIG. 1. The stored device fingerprints may be used by the device fingerprinting system to perform the downstream network operation, such as detecting MAC address spoofing, localizing devices, or provisioning quality of service. Following operation 618, method 600 may end.

In this way, method 600 enables a device fingerprinting system to intelligently select cross-layer features for device fingerprinting, tailored to the requirements of a particular downstream network operation. By iteratively adjusting the feature selection, extraction, and formulation processes, method 600 produces a set of device fingerprints that are well-suited for the intended application, while minimizing computational complexity and maximizing robustness and uniqueness.

The disclosure also provides support for a method comprising: monitoring network communication of a plurality of electronic devices, wherein the plurality of electronic devices are communicatively coupled to a wireless network, extracting cross-layer features for each of the plurality of electronic devices using the network communication, wherein the cross-layer features are selected based on a downstream network operation, storing the cross-layer features of each of the plurality of electronic devices in a device fingerprinting database, monitoring a network communication of an electronic device communicatively coupled to the wireless network, extracting the cross-layer features from the network communication of the electronic device, classifying the electronic device into a device category using the cross-layer features of the electronic device and the device fingerprinting database, and performing the downstream network operation on the electronic device based on the device category. In a first example of the method, the downstream network operation is one of media access control (MAC) address spoofing detection, device localization, quality of service (QOS) provisioning, access control, device authentication, device identification, and attack detection. In a second example of the method, optionally including the first example, the downstream network operation is MAC address spoofing detection, and wherein the cross-layer features include a MAC address and an error vector magnitude (EVM). In a third example of the method, optionally including one or both of the first and second examples, compiling the cross-layer features of each of the plurality of electronic devices into the device fingerprinting database includes: determining a plurality of MAC addresses for the plurality of electronic devices, determining one or more EVMs for each of the plurality of electronic devices, and storing the plurality of MAC addresses, and the one or more EVMs determined for each of the plurality of electronic devices, in the device fingerprinting database. In a fourth example of the method, optionally including one or more or each of the first through third examples, the cross-layer features of the electronic device comprise a first MAC address of the electronic device, and a first EVM of the electronic device, and wherein classifying the electronic device into the device category using the cross-layer features of the electronic device and the device fingerprinting database, comprises: determining if the first MAC address of the electronic device matches a second MAC address of the plurality of MAC addresses stored in the device fingerprinting database, and responding to the first MAC address matching the second MAC address by: accessing the one or more EVMs associated with the second MAC address, and determining the device category of the electronic device based on a comparison between the first EVM and the one or more EVMs associated with the second MAC address. In a fifth example of the method, optionally including one or more or each of the first through fourth examples, determining the device category of the electronic device based on the comparison between the first EVM and the one or more EVMs associated with the second MAC address comprises: determining a probability of the first EVM originating from a same device as the one or more EVMs based on a difference between the first EVM and each of the one or more EVMs associated with the second MAC address, and responding to the probability being less than a threshold probability by: setting the device category to indicate the first MAC address is spoofed. In a sixth example of the method, optionally including one or more or each of the first through fifth examples, determining the device category of the electronic device based on the comparison between the first EVM and the one or more EVMs associated with the second MAC address comprises: determining a probability of the first EVM originating from a same device as the one or more EVMs based on a difference between the first EVM and each of the one or more EVMs associated with the second MAC address, and responding to the probability being greater than a threshold probability by: setting the device category to indicate the first MAC address is not spoofed. In a seventh example of the method, optionally including one or more or each of the first through sixth examples, extracting the cross-layer features for each of the plurality of electronic devices using the network communication comprises: determining a plurality of cross-layer feature values for each of the plurality of electronic devices from distinct communications transmitted by each of the plurality of electronic devices, and determining one or more statistics based on the plurality of cross-layer feature values for each of the plurality of electronic devices. In a eighth example of the method, optionally including one or more or each of the first through seventh examples, the one or more statistics include one or more of a mean, a standard deviation, a range, and a variance of the plurality of cross-layer feature values for each of the plurality of electronic devices.

The disclosure also provides support for a system comprising: an edge device, a feature extraction module communicatively coupled to the edge device via a wireless network, and configured to extract cross-layer features from communications transmitted by the edge device, a device fingerprinting database comprising cross-layer features of each of a plurality of edge devices, a classifier module configured to determine a device category of the edge device based on the device fingerprinting database and the cross-layer features extracted from the communications transmitted by the edge device, and a downstream network operation module configured to perform a downstream network operation on the edge device based on the device category determined by the classifier module. In a first example of the system, the feature extraction module is configured to extract a plurality of error vector magnitude (EVM) values from communications transmitted by the edge device, and wherein the device fingerprinting database comprises, for each of the plurality of edge devices, an estimated probability distribution of a plurality of EVM values extracted from communications transmitted by the respective edge device. In a second example of the system, optionally including the first example, the classifier module is configured to determine the device category of the edge device by: extracting one or more EVM values from communications transmitted by the edge device, determining a probability that the one or more EVM values originate from the edge device based on the estimated probability distribution of the plurality of EVM values for the edge device stored in the device fingerprinting database, and classifying the edge device into the device category based on the determined probability. In a third example of the system, optionally including one or both of the first and second examples, the classifier module is configured to determine the probability that the one or more EVM values originate from the edge device by determining a probability that the one or more EVM values belong to the estimated probability distribution of the plurality of EVM values for the edge device stored in the device fingerprinting database. In a fourth example of the system, optionally including one or more or each of the first through third examples, the feature extraction module is configured to estimate the probability distribution of the plurality of EVM values for each of the plurality of edge devices by fitting a Gaussian distribution to the plurality of EVM values extracted for the respective edge device. In a fifth example of the system, optionally including one or more or each of the first through fourth examples, the device fingerprinting database stores, for each of the plurality of edge devices, a mean and a standard deviation of the Gaussian distribution fit to the plurality of EVM values extracted for the respective edge device.

The disclosure also provides support for a method comprising: monitoring a network communication of an electronic device communicatively coupled to a wireless network, determining cross-layer features based on a downstream network operation, extracting the cross-layer features from the network communication of the electronic device, classifying the electronic device into a device category using the cross-layer features of the electronic device and a device fingerprinting database, wherein the device fingerprinting database comprises the cross-layer features of each of a plurality of electronic devices, and performing the downstream network operation on the electronic device based on the device category. In a first example of the method, classifying the electronic device into the device category using the cross-layer features of the electronic device and the device fingerprinting database comprises: determining a similarity score between the cross-layer features of the electronic device and the cross-layer features of each of the plurality of electronic devices stored in the device fingerprinting database, and assigning the electronic device to the device category associated with the electronic device from the plurality of electronic devices having a highest similarity score. In a second example of the method, optionally including the first example, determining the similarity score comprises computing a distance metric between the cross-layer features of the electronic device and the cross-layer features of each of the plurality of electronic devices stored in the device fingerprinting database. In a third example of the method, optionally including one or both of the first and second examples, the method further comprises: monitoring network communications of the electronic device over a period of time, extracting the cross-layer features from the network communications at multiple time instances during the period of time, and updating the device fingerprinting database with the extracted cross-layer features at the multiple time instances. In a fourth example of the method, optionally including one or more or each of the first through third examples, the device fingerprinting database is compiled by: monitoring network communications of the plurality of electronic devices, extracting the cross-layer features for each of the plurality of electronic devices from the network communications, and storing the extracted cross-layer features for each of the plurality of electronic devices in the device fingerprinting database.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A method comprising:
monitoring network communication of a plurality of electronic devices, wherein the plurality of electronic devices are communicatively coupled to a wireless network;
extracting cross-layer features for each of the plurality of electronic devices using the network communication, wherein the cross-layer features are selected based on a downstream network operation;
storing the cross-layer features of each of the plurality of electronic devices in a device fingerprinting database;
monitoring a network communication of an electronic device communicatively coupled to the wireless network;
extracting the cross-layer features from the network communication of the electronic device;
classifying the electronic device into a device category using the cross-layer features of the electronic device and the device fingerprinting database; and
performing the downstream network operation on the electronic device based on the device category.

2. The method of claim 1, wherein the downstream network operation is one of media access control (MAC) address spoofing detection, device localization, quality of service (QOS) provisioning, access control, device authentication, device identification, and attack detection.

3. The method of claim 1, wherein the downstream network operation is MAC address spoofing detection, wherein the cross-layer features include a MAC address and an error vector magnitude (EVM), and wherein the EVM is correlated to one or more of a phase noise, an I/Q imbalance, nonlinearities in a power amplifier, and quantization noise in an analog-to-digital converter, of the electronic device.

4. The method of claim 3, wherein compiling the cross-layer features of each of the plurality of electronic devices into the device fingerprinting database includes:
determining a plurality of MAC addresses for the plurality of electronic devices;
determining one or more EVMs for each of the plurality of electronic devices; and storing the plurality of MAC addresses, and the one or more EVMs determined for each of the plurality of electronic devices, in the device fingerprinting database.

5. The method of claim 4, wherein the cross-layer features of the electronic device comprise a first MAC address of the electronic device, and a first EVM of the electronic device, and wherein classifying the electronic device into the device category using the cross-layer features of the electronic device and the device fingerprinting database, comprises:
determining if the first MAC address of the electronic device matches a second MAC address of the plurality of MAC addresses stored in the device fingerprinting database; and
responding to the first MAC address matching the second MAC address by:
accessing the one or more EVMs associated with the second MAC address; and
determining the device category of the electronic device based on a comparison between the first EVM and the one or more EVMs associated with the second MAC address.

6. The method of claim 5, wherein determining the device category of the electronic device based on the comparison between the first EVM and the one or more EVMs associated with the second MAC address comprises:
determining a probability of the first EVM originating from a same device as the one or more EVMs based on a difference between the first EVM and each of the one or more EVMs associated with the second MAC address; and
responding to the probability being less than a threshold probability by:
setting the device category to indicate the first MAC address is spoofed.

7. The method of claim 5, wherein determining the device category of the electronic device based on the comparison between the first EVM and the one or more EVMs associated with the second MAC address comprises:
determining a probability of the first EVM originating from a same device as the one or more EVMs based on a difference between the first EVM and each of the one or more EVMs associated with the second MAC address; and
responding to the probability being greater than a threshold probability by:
setting the device category to indicate the first MAC address is not spoofed.

8. The method of claim 1, wherein extracting the cross-layer features for each of the plurality of electronic devices using the network communication comprises:
determining a plurality of cross-layer feature values for each of the plurality of electronic devices from distinct communications transmitted by each of the plurality of electronic devices; and
determining one or more statistics based on the plurality of cross-layer feature values for each of the plurality of electronic devices.

9. The method of claim 8, wherein the one or more statistics include one or more of a mean, a standard deviation, a range, and a variance of the plurality of cross-layer feature values for each of the plurality of electronic devices.

10. A system comprising:
an edge device;
a feature extraction module communicatively coupled to the edge device via a wireless network, and configured to extract cross-layer features from communications transmitted by the edge device;
a device fingerprinting database comprising cross-layer features of each of a plurality of edge devices;
a classifier module configured to determine a device category of the edge device based on the device fingerprinting database and the cross-layer features extracted from the communications transmitted by the edge device; and
a downstream network operation module configured to perform a downstream network operation on the edge device based on the device category determined by the classifier module.

11. The system of claim 10, wherein the feature extraction module is configured to extract a plurality of error vector magnitude (EVM) values from communications transmitted by the edge device, and wherein the device fingerprinting database comprises, for each of the plurality of edge devices, an estimated probability distribution of a plurality of EVM values extracted from communications transmitted by the respective edge device.

12. The system of claim 11, wherein the classifier module is configured to determine the device category of the edge device by:
extracting one or more EVM values from communications transmitted by the edge device;
determining a probability that the one or more EVM values originate from the edge device based on the estimated probability distribution of the plurality of EVM values for the edge device stored in the device fingerprinting database; and
classifying the edge device into the device category based on the determined probability.

13. The system of claim 12, wherein the classifier module is configured to determine the probability that the one or more EVM values originate from the edge device by determining a probability that the one or more EVM values belong to the estimated probability distribution of the plurality of EVM values for the edge device stored in the device fingerprinting database.

14. The system of claim 11, wherein the feature extraction module is configured to estimate the probability distribution of the plurality of EVM values for each of the plurality of edge devices by fitting a Gaussian distribution to the plurality of EVM values extracted for the respective edge device.

15. The system of claim 14, wherein the device fingerprinting database stores, for each of the plurality of edge devices, a mean and a standard deviation of the Gaussian distribution fit to the plurality of EVM values extracted for the respective edge device.

16. A method comprising:
monitoring a network communication of an electronic device communicatively coupled to a wireless network;
determining cross-layer features based on a downstream network operation;
extracting the cross-layer features from the network communication of the electronic device;
classifying the electronic device into a device category using the cross-layer features of the electronic device and a device fingerprinting database, wherein the device fingerprinting database comprises the cross-layer features of each of a plurality of electronic devices; and
performing the downstream network operation on the electronic device based on the device category.

17. The method of claim 16, wherein classifying the electronic device into the device category using the cross-layer features of the electronic device and the device fingerprinting database comprises:
determining a similarity score between the cross-layer features of the electronic device and the cross-layer features of each of the plurality of electronic devices stored in the device fingerprinting database; and
assigning the electronic device to the device category associated with the electronic device from the plurality of electronic devices having a highest similarity score.

18. The method of claim 17, wherein determining the similarity score comprises computing a distance metric between the cross-layer features of the electronic device and the cross-layer features of each of the plurality of electronic devices stored in the device fingerprinting database.

19. The method of claim 16, further comprising:
monitoring network communications of the electronic device over a period of time;
extracting the cross-layer features from the network communications at multiple time instances during the period of time; and
updating the device fingerprinting database with the extracted cross-layer features at the multiple time instances.

20. The method of claim 16, wherein the device fingerprinting database is compiled by:
monitoring network communications of the plurality of electronic devices;
extracting the cross-layer features for each of the plurality of electronic devices from the network communications; and
storing the extracted cross-layer features for each of the plurality of electronic devices in the device fingerprinting database.
